(19) United States
(12) Patent Application Publication
(10) Pub. No.: US 2012/0027105 A1
(43) Pub. Date: Feb. 2, 2012

(54) CHANNEL ESTIMATOR

(75) Inventors: Andrew Nix, Bristol (GB); Simon Armour, Bath and Northeast Somerset (GB); Gillian Huang, Bristol Avon (GB)

(73) Assignee: THE UNIVERSITY OF BRISTOL, Clifton, Bristol (GB)

(21) Appl. No.: 13/147,067

(22) PCT Filed: Sep. 24, 2010
(86) PCT No.: PCT/US2010/050224

§ 371 Date: Sep. 20, 2011

Related U.S. Application Data
(63) Continuation of application No. 12/650,932, filed on Dec. 31, 2009.

(51) Int. Cl. H04L 27/00

(52) U.S. Cl. 375/259

(57) ABSTRACT

There is provided a channel estimator for a receiver in a communication system, the channel estimator comprising an input for receiving signals that have been transmitted over a transmission channel; processing means for determining an initial estimate of the channel impulse response of the transmission channel from the received signals, the determined initial estimate comprising a plurality of taps; and determining a further estimate of the transmission channel from the initial estimate; wherein the processing means is configured to apply a weighting to a subset of the plurality of taps from the initial estimate in determining the further estimate, the value of the weighting being determined according to a quality of the received signals.

### TECHNICAL FIELD OF THE INVENTION

The invention relates to a channel estimator for a receiver in a communication system.

### BACKGROUND TO THE INVENTION

In wireless communication systems, an equalizer is used at the receiver to combat signal distortion that arises from the frequency-selective fading channel. To implement the equaliser, a channel estimator is required to initially estimate the channel response.

Since the design of the equalizer is based on the channel estimate provided by the channel estimator, inaccurate channel estimates give rise to inaccurate equalizer coefficients, which then lowers the overall performance of the receiver (whether in a mobile device or base station). This reduction in performance results in the overall receiver sensitivity being degraded, which reduces the coverage area.

The widely used least squares (LS) channel estimator gives a 3-4 dB performance loss compared to an ideal channel estimator. This performance loss is significant for a mobile communication system due to restrictions on transmission power. Other channel estimation methods have been proven, in theory, to offer superior estimation accuracy, but these methods suffer from high computational complexity making them difficult to implement and expensive in terms of both hardware cost and power consumption. Of course, power consumption is well established as a key constraint in mobile device design, and is an issue of increasing concern in base station design.

Although various DFT-based channel estimators have been proposed, most are not suited to practical implementation for various reasons. For example, a denoise estimator (as described in “On Channel Estimation in OFDM Systems” by van de Beek, Edfors, Sandell, Wilson and Börjesson in Proc. VTC '95—Spring, vol. 2, pp. 815-819, July 1995) can reduce the estimation noise at low signal-to-noise ratios (SNRs), compared to a LS channel estimator, but gives an error floor at high SNRs. A linear minimum mean square error (LMMSE) estimator gives the best performance, and is also described in “On Channel Estimation in OFDM Systems”). However, the LMMSE estimator requires a very high complexity and knowledge of the channel correlation, which is normally unknown in practice. An approximate LMMSE (Approx-LMMSE) estimator gives a good compromise between performance and complexity, but knowledge of channel correlation is still required—again this is normally unknown in practice. The Approx-LMMSE estimator is described in “Analysis of DFT-based channel estimators for OFDM” by van de Beek, Edfors, Sandell, Wilson and Börjesson in Wireless Personal Commun., vol. 12, no. 1, pp. 55-70, January 2000.

FIG. 1 is a graph comparing the performance of an ideal channel estimator with LS, denoise, LMMSE and Approx-LMMSE channel estimators in a localised frequency division multiple access (LFDMA) system with 16QAM used as the baseband modulation scheme.

FIG. 2 is a block diagram illustrating an exemplary LFDMA system 2, comprising a transmitter 4 and receiver 6.

The baseband transmit symbols, denoted xₘ, where m=0, . . . , M−1 and M is the number of user subcarriers, are provided to transmitter 4. After a serial to parallel conversion in block 8, an M-point discrete Fourier transform (DFT) block 10 converts the transmit symbols into the frequency domain.

Subcarrier mapping is performed in block 12, and the sampling rate increases after an N-point inverse DFT (IDFT) in block 14, where N is the total number of available subcarriers.

The output of the IDFT block 14 is converted back into a serial form (block 16), a cyclic prefix (CP) is inserted (block 18) and the resulting signals are transmitted over a channel 20. During the transmission over the channel 20, noise 22 will be added to the signal.

The receiver 6 reverses the operations performed in the transmitter 4 in order to recover the transmit symbols. Thus, the receiver 6 comprises a block 24 for removing the cyclic prefix, an N-point DFT block 28, a subcarrier demapping block 30 and M-point IDFT block 32.

The effect of the equivalent channel impulse response (CIR) in the receiver 6 after localized subcarrier demapping in block 30 and M-point IDFT in block 32 is denoted as g_{I}. Hence, the unequalized received baseband symbols can be described as

$${y}_{m} = {\sum }_{I = 0}^{M - 1} {g}_{I} {x}_{m - I} + {η}_{m} \qquad ( 1 )$$

where m=0, . . . , M−1, and ηₘ denotes the equivalent received noise.

The equivalent channel impulse response g_{I} is illustrated in the graphs of FIG. 3.

h′ₚ and g′ₙ denote the frequency domain (FD) channel response and the channel impulse response (in the time domain) before subcarrier demapping, as shown in FIGS. 3(a) and 3(b) respectively.

The localized subcarrier demapping block 30 can be described by a rectangular window function, as shown in FIG. 3(c), i.e.

$${u}_{p}^{′} = \{ \begin{matrix}1 , & p = 0 , … , M - 1 \\ 0 , & p = M , … , N - 1\end{matrix} \qquad ( 2 )$$

The frequency domain rectangular window results in a sinc-like function in the time domain (TD) as shown in FIG. 3(d), i.e.

$${d}_{n}^{′} = {e}^{j \frac{π}{N} n ( M - 1 )} \frac{sin ( π \frac{nM}{N} )}{sin ( π \frac{n}{N} )} , n = 0 , … , N - 1 \qquad ( 3 )$$

FIG. 3(e) illustrates that the localized subcarrier demapping is a frequency domain multiplication process, i.e. u′ₚh′ₚ. This is equivalent to a cyclic convolution of the channel impulse response and the sinc-like function in the time domain, i.e. g′ₙ*d′ₙ, as shown in FIG. 3(f).

After downsampling, hₖ denotes the frequency domain channel response experienced by the receiver (see FIG. 3(g)) and g_{I} denotes the equivalent channel impulse response (see FIG. 3(h)).

As shown in FIG. 3(h), the energy of the equivalent channel impulse response is primarily concentrated in a few taps.

If sₖ and rₖ are considered to respectively denote the transmit and receive frequency domain pilot symbols, the frequency domain least squares (LS) channel estimate can be obtained using

$${\hat{h}}_{LS , k} = \frac{{r}_{k}}{{s}_{k}} = {h}_{k} + {ɛ}_{k} , k = 0 , … , M - 1 \qquad ( 4 )$$

where εₖ denotes the least squares estimation noise. ĥ_{LS,k} is the noisy observation of the true frequency domain channel hₖ and the corresponding least squares channel impulse response is

$${\hat{g}}_{LS , l} = \frac{1}{M} {\sum }_{k = 0}^{M - 1} {\hat{h}}_{LS , k} {e}^{j \frac{2 π}{M} kl} \qquad ( 5 )$$

Let ĝ_{LS}=[ĝ_{LS,0}, . . . , ĝ_{LS,M-1}]^{T}. The DFT-based channel estimator, denoted as a matrix Q, can be used for noise filtering in the time domain.

Hence a better channel impulse response ĝ can be obtained via

ĝ=Qĝ_{LS} (6)

where ĝ=[ĝ₀, . . . , ĝ_{M-1}]^{T}.

Finally, ĝ_{I} is converted back to the frequency domain, i.e.

$${\hat{h}}_{k} = {\sum }_{l = 0}^{M - 1} {\hat{g}}_{l} {e}^{- j \frac{2 π}{M} kl} \qquad ( 7 )$$

for frequency domain equalisation (FDE).

For the conventional denoise estimator, it is assumed that the energy of ĝ_{LS} decreases rapidly outside the first L taps, where L is the equivalent maximum channel delay spread (or an estimate thereof) or the equivalent cyclic prefix length normalised to the user symbol rate, and the noise energy is considered to be constant over the entire range.

In the denoise estimator described in “On Channel Estimation in OFDM Systems” referenced above, a subset of the taps of ĝ_{LS} is used in the channel estimation, and in particular the first L taps and an additional S taps on each side, where S denotes the number of taps that have significant smearing energy to be excluded from denoising (i.e. they are to be included in the channel estimation).

Mathematically, referring to equation (6) above, this denoise estimator can be described as

$$Q = diag [ {\overbrace{1 , … , 1}}^{L + S} , {\overbrace{0 , … , 0}}^{M - L - 2 S} , {\overbrace{1 , … , 1}}^{S} ] \qquad ( 8 )$$

which is an M×M matrix. Relating this back to the channel impulse response shown in FIG. 3(h), Q has the effect of retaining the energy associated with the taps at the lower values (L+S) and upper values (S) of I, while excluding the energy associated with the taps in the middle values, which are considered to contain mainly noise.

However, as described above, although this denoise estimator can reduce the estimation noise at low signal-to-noise ratios (SNRs) compared to a LS channel estimator, an error floor exists at high SNRs.

Thus, it would be desirable to provide an alternative channel estimator that provides a significant performance improvement over the LS channel estimator, without the complexity disadvantages associated with other designs.

### SUMMARY OF THE INVENTION

According to a first aspect of the invention, there is provided a channel estimator for a receiver in a communication system, the channel estimator comprising an input for receiving signals that have been transmitted over a transmission channel; processing means for determining an initial estimate of the channel impulse response of the transmission channel from the received signals, the determined initial estimate comprising a plurality of taps; and determining a further estimate of the transmission channel from the initial estimate; wherein the processing means is configured to apply a weighting to a subset of the plurality of taps from the initial estimate in determining the further estimate, the value of the weighting being determined according to a quality of the received signals.

According to a second aspect of the invention, there is provided a method of estimating a channel, the method comprising receiving signals that have been transmitted over a transmission channel; determining an initial estimate of the channel impulse response of the transmission channel from the received signals, the determined initial estimate comprising a plurality of taps; and determining a further estimate of the transmission channel from the initial estimate by applying a weighting to a subset of the plurality of taps from the initial estimate, wherein the value of the weighting is determined according to a quality of the received signals.

### BRIEF DESCRIPTION OF THE DRAWINGS

Exemplary embodiments of the invention will now be described, by way of example only, with reference to the following drawings, in which:

FIG. 1 is a graph illustrating the performance differences between various conventional channel estimators;

FIG. 2 is a block diagram showing a localised frequency division multiple access (LFDMA) system;

FIGS. 3(a)-(h) illustrate the channel response in the frequency and time domains;

FIG. 4 is a block diagram of a channel estimator according to the invention;

FIG. 5 is a graph illustrating the performance in terms of mean squared error of the invention over conventional channel estimators;

FIG. 6 is a graph illustrating the performance in terms of bit error rate of the invention over conventional channel estimators;

FIG. 7 is a graph illustrating the variation of the weighting value with the signal to noise ratio in an embodiment of the invention;

FIGS. 8(a)-(c) illustrate alternative embodiments of the invention;

FIG. 9 illustrates the multiplication coefficients for a DCT-based channel estimator; and

FIG. 10 illustrates the multiplication coefficients for a generalised transform-based channel estimator.

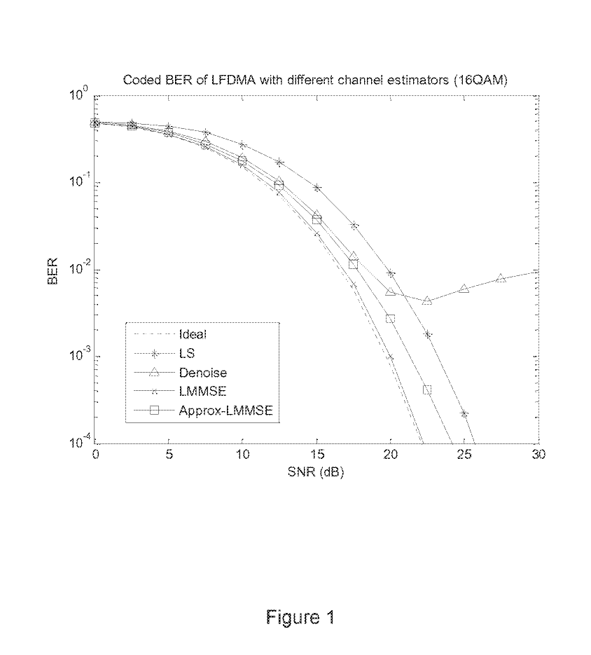

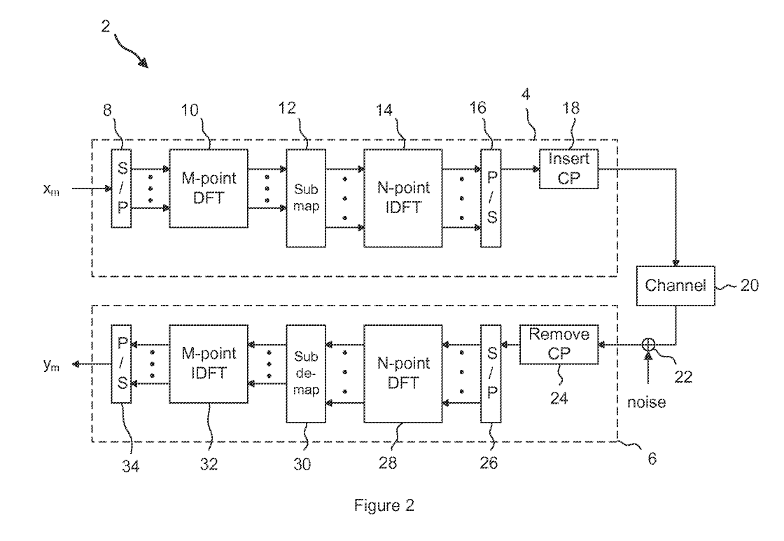

### DETAILED DESCRIPTION OF THE PREFERRED EMBODIMENTS

Although the invention will be described herein as a channel estimator for a localised frequency division multiple access (LFDMA) communication system, it will be appreciated by a person skilled in the art that the invention is not limited to this implementation, and the invention can be applied to other frequency domain equalisation (FDE) based systems, for example, orthogonal frequency division multiplexing (OFDM), orthogonal frequency division multiple access (OFDMA) with localised subcarrier mapping scheme, and single carrier frequency domain equalisation (SC-FDE).

As described above, although the conventional denoise estimator can reduce the estimation noise at low signal-to-noise ratios compared to a LS channel estimator, an error floor exists at high SNRs, which significantly impacts the usefulness of this estimator.

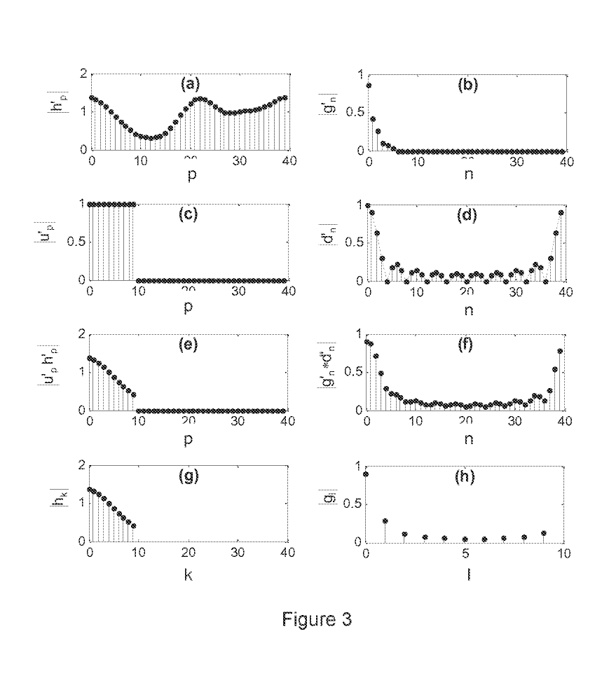

It has been noted above that most of the channel energy is concentrated in a few taps. However, due to energy smearing (as shown in FIGS. 3(f) and (h)), the subset of taps excluded by the denoising process will still contain some information that is required for reconstructing the true frequency domain channel response (shown in FIG. 3(g)).

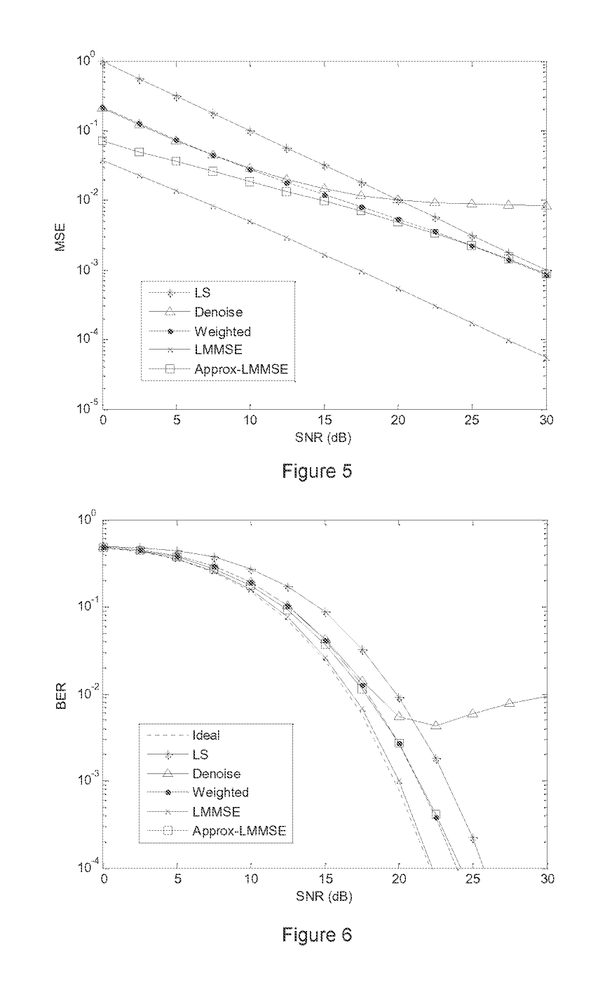

In particular, if S is determined using a sinc function according to the requirement of energy concentration, it can be shown that for S=5 (which is used in the examples given in “On Channel Estimation in OFDM Systems”), the energy concentration will be around 99%, which means that approximately 1% of the channel energy will be truncated by the denoise channel estimator. This truncation leads to the estimation error floor shown in FIG. 5 and therefore results in an error floor in BER, as shown in FIG. 6.

Therefore, in accordance with the invention, the error floor problem is overcome by applying a weighting to the low energy taps that varies with the quality of the signal.

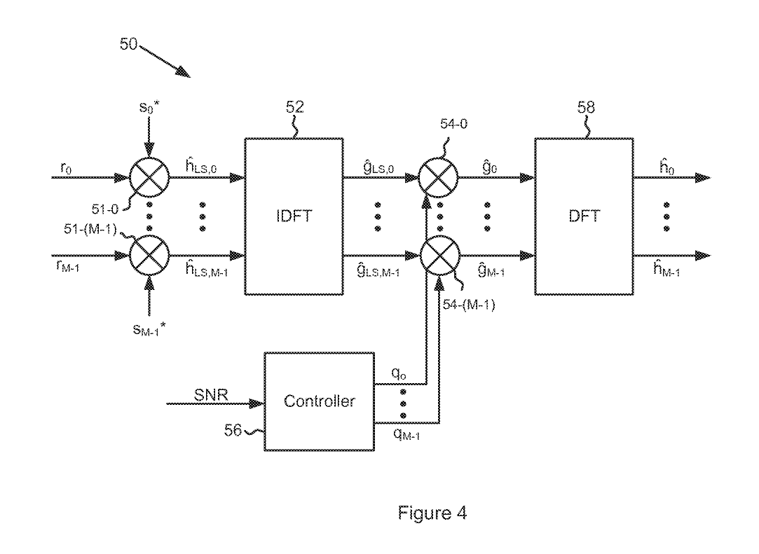

Part of an exemplary channel estimator 50 in accordance with the invention is presented in FIG. 4. The channel estimator 50 comprises a Least Squares (LS) channel estimator followed by a discrete Fourier transform (DFT) based estimator. The channel estimator 50 determines an initial estimate of the channel that includes noise in the frequency domain (FD) using pilot symbols that are known to both the transmitter 4 and the receiver 6.

If sₖ denotes the transmitted pilot signal in the frequency domain, the received frequency domain pilot signal rₖ can be described as

rₖ=hₖsₖ+nₖ, k=0, . . . , M−1 (9)

where hₖ is the frequency domain channel response and nₖ is the received noise in the frequency domain.

As shown in FIG. 4, the LS channel estimator aims to estimate the channel from the received frequency domain pilot signal rₖ and the LS estimator coefficients are the complex conjugate (denoted by *) of the known pilot signal, i.e. sₖ*. The estimator coefficients sₖ* are combined with their respective received frequency domain pilot signals rₖ by multipliers 51-0 to 51-(M−1). Therefore, the frequency domain LS estimation can be described as

ĥ_{LS,k}=sₖ*rₖ=sₖ*(hₖsₖ+nₖ)=hₖ+sₖ*nₖ=hₖ+εₖ (10)

where εₖ is the LS estimation noise.

This initial channel estimate ĥ_{LS} is provided to an inverse discrete Fourier transform (IDFT) block 52 that transforms the initial channel estimate into the time domain (TD), to give a noisy estimate of the channel impulse response (CIR), denoted ĝ_{LS}=[g_{LS,0}, . . . , ĝ_{LS,M-1}]. Each of the elements ĝ_{LS,I} in the channel impulse response is referred to herein as a “tap”.

Each tap or element of ĝ_{LS} is provided to a respective multiplier 54-0 to 54-(M−1), along with a respective multiplication coefficient q_{I} for each of the elements where I=0, . . . , M−1.

A controller 56 generates the multiplication coefficients q_{I} and provides these to the multipliers 54. The controller 56 also has an input for receiving an indication of a quality of the received signals, which, in this embodiment, is a signal to noise ratio (SNR). In alternative embodiments, the indication of a quality of the received signals can be a received signal strength indicator (RSSI) or a channel quality indicator (CQI), for example.

The output of the multipliers 54 is an improved (further) channel impulse response estimate ĝ (i.e. improved in the sense that the presence of noise has been reduced) and this estimate is provided to a discrete Fourier transform (DFT) block 58, which transforms the estimate back into the frequency domain to give an improved channel response estimate ĥ.

The channel response estimate ĥ can then be used in frequency domain equalisation (FDE).

Thus, the error floor problem with conventional denoise estimators is overcome by the controller 56 being configured to adapt the values of the subset of the multiplication coefficients q_{I} for the taps in the middle portion of the channel impulse response (i.e. the energy smeared taps) in accordance with the quality of the received signals.

Mathematically, the operation of the multipliers 54 and the controller 56 is shown by equation (6) with Q being given, in a preferred embodiment, by:

$$Q = diag [ {\overbrace{1 , … , 1}}^{L + S} , {\overbrace{w , … , w}}^{M - L - 2 S} , {\overbrace{1 , … , 1}}^{S} ] \qquad ( 11 )$$

where w is a weighting coefficient that is to be applied to the M+L+2S taps in the middle of the channel impulse response (i.e. the energy smeared taps), and which has a value 0≦w≦1. The taps in the end portions of the channel impulse response (i.e. in the first L+S taps and last S taps) are referred to herein as the energy concentrated taps. It will be appreciated that the values of the multiplication coefficients q_{I} in FIG. 4 correspond to the values along the diagonal of the matrix Q in equation (11).

In this embodiment of the invention, the value of w is uniform for all of the energy smeared taps in the middle portion of the channel impulse response, i.e. the value of w is the same for each of the taps.

The matrix (11) can alternatively be understood as the controller 56 providing the following multiplication coefficients to the multipliers 54:

$${q}_{l} = \{ \begin{matrix}1 & l = 0 , … , L + S - 1 \\ w & l = L + S , … , M - S - 1 \\ 1 & l = M - S , … , M - 1\end{matrix} \qquad ( 12 )$$

In a preferred embodiment, the controller 56 is configured to adapt the value of w (and therefore the corresponding multiplication coefficients q_{I} such that w tends to 0 for low values of the SNR, and the value of w tends to 1 for high values of the SNR.

In this way, when the signal to noise ratio is relatively low, and the noise component is dominating the signal on each of the middle set of taps in the channel impulse response, the contribution of these taps to the final channel estimate in the frequency domain is eliminated (i.e. when w=0) or substantially reduced (i.e. when w≈0).

Conversely, when the signal to noise ratio is relatively high, the dominant part of the signal on each of the taps in the middle of the channel impulse response will be the useful signal information, so these taps are used (i.e. w=1), or substantially used (i.e. when w≈1) in the final channel estimate in the frequency domain.

The cost function is the mean square error (MSE) in the range of the weighting, i.e.

$$J = E [ {\sum }_{l = L + S}^{M - S - 1} {\vert w {\hat{g}}_{LS , l} - {g}_{l} \vert}^{2} ] \qquad ( 13 )$$

By applying the gradient method to equation (11), i.e.

$$\frac{\partial J}{\partial w} = 0 ,$$

the optimum weight w can be calculated as

$$w = \frac{{\sum }_{l = L + S}^{M - S - 1} {\vert {\hat{g}}_{LS , l} \vert}^{2} - ( M - L - 2 S ) \frac{{σ}_{ɛ}^{2}}{M}}{{\sum }_{l = L + S}^{M - S - 1} {\vert {\hat{g}}_{LS , l} \vert}^{2}} \qquad ( 14 )$$

where σ_{ε}²=└|εₖ|²┘ is the estimation noise power.

Thus, by evaluating equation (14), the controller 56 can dynamically determine the optimum value of w for the current signal to noise ratio.

A comparison of the performance of the invention with the ideal channel estimate, a conventional denoise estimator and LS, LMMSE and Approximate-LMMSE channel estimators is illustrated in FIGS. 5 and 6.

In a particular example, in a simulation of an LFDMA system, the total number of available subcarriers N is 512 and the number of user subcarriers M is 128. The subcarrier spacing is 15 kHz and the sample period is Tₛ=(15 kHz×512)⁻¹=0.1302 μs. The cyclic prefix (CP) length is set to P=64 (i.e. 8.33 μs). The urban macro scenario of the spatial channel model extended (SCME) is used, and the CP length is thus longer than the maximum channel delay spread of 4.60 μs. An MMSE-FDE is used at the receiver 6. The channel coding is a 1/2-rate convolutional code and the baseband modulation is 16QAM. It is assumed that pilot symbols based on a Chu sequence occupy all of the subcarriers that belong to the same user.

For the conventional denoise estimator and the weighted estimator according to the invention, the number of significant energy smearing taps is set to S=5 and the equivalent CP length is L=P×M/N=16. For the LMMSE and Approx-LMMSE estimators, perfect knowledge of channel correlation is used although this is normally unknown in practice.

FIG. 5 shows a mean square error (MSE) comparison of the DFT-based channel estimators. The LMMSE estimator has the lowest MSE. Compared to the LS estimator, the conventional denoise estimator gives a lower MSE at low SNR but results in an error floor of MSE≈10⁻² at high SNR due to the truncation of 1% of the channel energy. In contrast to the denoise estimator, the weighted estimator according to the invention maintains a low MSE at low SNRs and converges to the LS estimator at high SNRs. It is worth noting that the weighted estimator has a comparable MSE performance to the Approx-LMMSE estimator for moderate to high SNRs. In fact, the weighted estimator outperforms the Approx-LMMSE estimator slightly at high SNRs.

FIG. 6 shows a comparison of the coded bit error rate (BER) performance with the DFT-based channel estimators, which is consistent with the results shown in FIG. 5. Compared to the case of an ideal channel estimate, the LMMSE estimator gives very little performance loss, while the LS estimator results in a 3.5 dB performance loss at a BER=10⁻³. It is shown that the weighted estimator outperforms the LS estimator by 2 dB and performs within 1.3 dB of the LMMSE estimator at a BER=10⁻³. Both the weighted estimator and the Approx-LMMSE estimator have a similar BER, but the weighted estimator has the advantage that knowledge of the channel correlation is not required.

In a further embodiment of the invention, the controller 56 can implement a simplified derivation of the weighting value w. In particular, the controller 56 can include a look-up table that provides values of w for corresponding values of the signal to noise ratio.

For a known value of M and L, and a predefined value of S, the calculation of the uniform weighting value w can be approximated to a function of the signal to noise ratio only as:

$$w ( SNR ) \approx {[ 1 + \frac{( M - L - 2 S )}{M} \cdot \frac{1}{\overline{ρ} ( S )} \cdot \frac{1}{SNR} ]}^{- 1} \qquad ( 15 )$$

where ρ̅(S) is the average ratio of the smeared energy in the weighting range (i.e. the middle set of taps) to total energy. For a known value of S, the energy concentration can be estimated using a sinc function (as described above). In particular, when S=5, ρ̅(S)=0.01.

It has been found that the simplification of the calculation of was shown in equation (15) results in a small degradation in the performance of the channel estimation at higher signal to noise ratios compared to the optimum value for the weighting value w, but the performance of the channel estimation is still significantly better than the conventional least squares channel estimator.

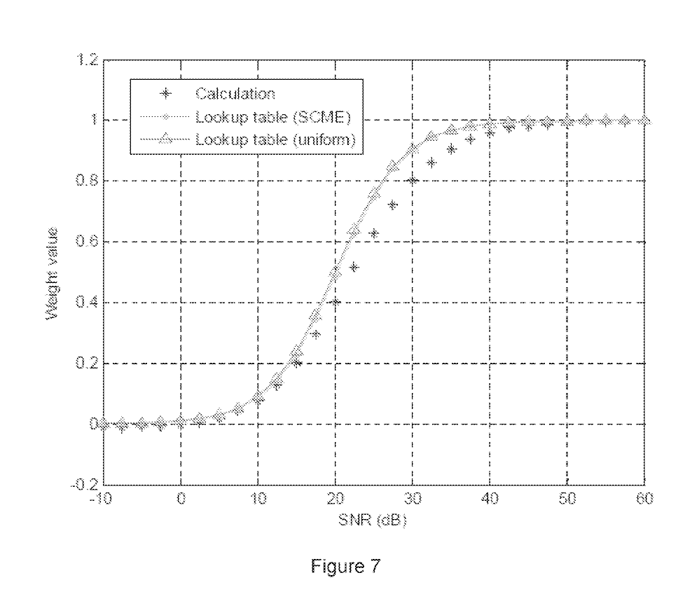

FIG. 7 illustrates how the value of w varies with the signal to noise ratio in accordance with embodiments of the invention. Thus, it can be seen that as the signal to noise ratio decreases, w tends to 0, and as the signal to noise ratio increases, w tends to 1. It can also be seen that due to the assumptions required to generate the look-up table, the values of w in this embodiment are slightly different to the values obtained from the optimum equation (equation (14)), which accounts for the slight degradation in performance experienced by the look-up table embodiment.

It will be appreciated by a person skilled in the art that the division of the taps in the channel impulse response into the energy smeared and energy concentrated portions can be different to that shown in equations (11) and (12). For example, the divisions can be based on a parameter other than the maximum channel delay spread or the equivalent cyclic prefix length (L).

In further embodiments of the invention, it will be appreciated that the channel estimator 50 can be configured so that the multiplication coefficients for the taps in the end portions of the channel impulse response (i.e. the first L+S taps and last S taps in the example of equation (11)) are fixed at 1, and the controller 56 can be configured to only output multiplication coefficients for the taps that need to be weighted (i.e. the middle M−L−2S taps). Indeed, it will be further appreciated that the multipliers 54 for the taps in the end portions of the channel impulse response can be omitted, thereby reducing the hardware requirements of the channel estimator 50.

Although the value of w has been defined as uniform across the taps in the middle portion of the channel impulse response, it will be appreciated that, in alternative embodiments, the value of w can be set to be non-uniform across the taps (i.e. the value of w can vary across the taps).

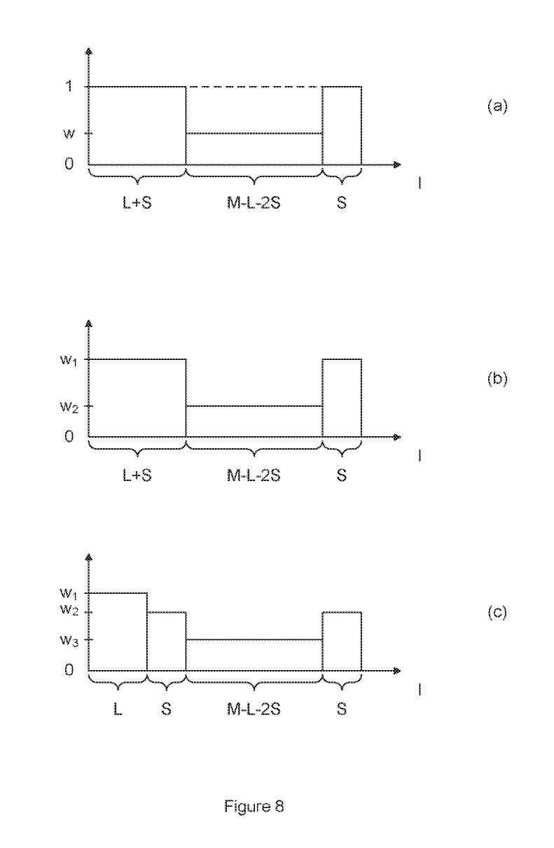

Some further embodiments of the invention are illustrated with reference to FIGS. 8(a)-(c).

FIG. 8(a) illustrates the general embodiment described above, in which the energy concentrated taps (i.e. the first L+S taps and the last S taps) have a uniform multiplication coefficient of 1, and the energy smeared taps (i.e. the remaining M−L−2S taps) have a uniform multiplication coefficient w which varies in accordance with a signal quality parameter.

FIG. 8(b) illustrates an embodiment of the invention in which the multiplication coefficient for the energy concentrated taps w₁ can vary in accordance with a signal quality parameter or any other desired parameter, in addition to the multiplication coefficient for the energy smeared taps w₂ being varied in accordance with the signal quality parameter. It will be appreciated that the two multiplication coefficients w₁ and w₂ are not equal, and the multiplication coefficient for the energy concentrated taps w₁ should be significantly higher than the multiplication coefficient for the energy smeared taps w₂.

FIG. 8(c) illustrates an embodiment of the invention in which a first multiplication coefficient w₁ is applied to the first L taps, a second multiplication coefficient w₂ is applied to the next S taps and the last S taps, and a third multiplication coefficient w₃ is applied to the middle M−L−2S taps. Again, each of the multiplication coefficients varies in accordance with a signal quality parameter or any other desired parameter. An approximate relationship between the three multiplication coefficients w₁, w₂ and w₃ can be seen in FIG. 8(c), with w₁>w₂>w₃. Thus, in this embodiment, the taps are divided into more than two portions, and the weighting applied to the taps in the energy concentrated portion is not uniform.

As shown in this embodiment, a portion can be formed from taps that are distributed across the range I, and that are not necessarily adjacent to each other.

It will be appreciated by a person skilled in the art that the number of portions the taps are divided into, as well as the size (i.e. number of taps) of each portion can be set depending on the specific application for the channel estimator. In addition, the applied weighting can be uniform or vary across each portion.

In each of the embodiments of the invention described above, processing is performed in the time domain via DFT as shown in FIG. 4. However, it will be appreciated by those skilled in the art that other transformations and domains can be used. For example, in alternative implementations, the channel estimation can be performed in the eigen domain via a unitary transformation (UT), or the channel estimation can be performed in the transform domain via any orthogonal transform, such as Karhunen-Loeve transforms (KLT), discrete cosine transforms (DCT) or Walsh-Hadamard transforms (WHT), can be used.

It will also be appreciated by those skilled in the art that different transformations result in a different distribution of channel energy in the transform domain. In other words, this means that the energy concentration region(s) (whose multiplication coefficient is 1 in FIG. 7) and noise suppression region(s) (whose multiplication coefficients are given by w in FIG. 7) in the transform domain may vary depending on the particular transformation being used.

For example, as described above, the use of DFTs results in the channel energy being concentrated in two regions, the first L+S taps and the last S taps (see FIG. 7). The remaining taps form the noise suppression region.

However, a different division between the energy concentration and noise suppression regions occurs when a discrete cosine transformation (DCT) is used. In particular, a DCT achieves a better energy compaction performance than the DFT and hence a better noise filtering performance.

The LS channel estimate in the DCT domain can be described as

$${\hat{g}}_{LS , l} = \frac{{w}_{l}}{\sqrt{M}} {\sum }_{k = 0}^{M - 1} {\hat{h}}_{LS , k} cos ( \frac{π ( 2 l + 1 ) k}{2 M} ) l = 0 , … , M - 1 \qquad ( 16 )$$

where w_{I}=1 for I=0 and w_{I}=√2 for I=1, . . . , M−1.

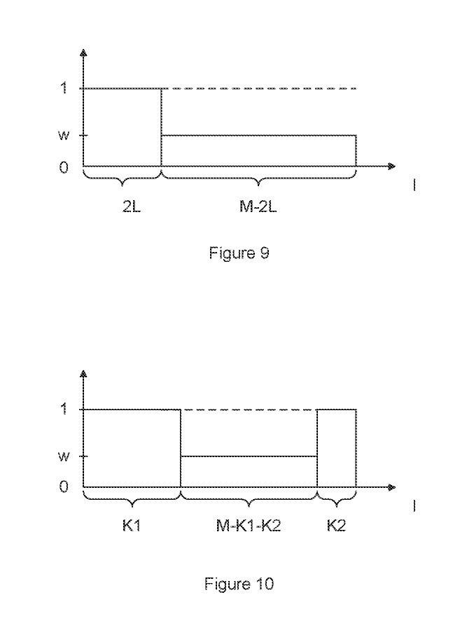

It has been found that, for a DCT, it is more appropriate to divide the taps into a single energy concentration region and a single noise suppression region, as illustrated in FIG. 9. Thus, the multiplication coefficients for a DCT-based channel estimator are defined as

$${q}_{l} = \{ \begin{matrix}1 , & for l = 0 , … , 2 L - 1 \\ w , & for l = 2 L , … , M - 1\end{matrix} \qquad ( 17 )$$

where L is the maximum channel delay spread or the CP length normalized to the user symbol rate. The weight w can be calculated according to the signal-to-noise ratio in the noise suppression region in the DCT-domain.

Taking the inverse DCT (IDCT) of the filtered transform taps ĝ_{I} gives the filtered frequency domain channel estimate as

$${\hat{h}}_{k} = \frac{1}{\sqrt{M}} {\sum }_{k = 0}^{M - 1} {w}_{l} {\hat{g}}_{l} cos ( \frac{π ( 2 l + 1 ) k}{2 M} ) , k = 0 , … , M - 1 \qquad ( 18 )$$

FIG. 10 illustrates a general embodiment of the invention for a channel estimator that uses some transformation to convert the frequency domain channel impulse response into a transform domain, and an inverse of the transformation to convert the improved channel impulse response back into the frequency domain.

Regardless of the transform being used, the taps in the transform domain are weighted for noise filtering. As illustrated above, different transforms result in different energy compaction characteristics, so the division between energy concentration region(s) and noise suppression region(s) will be different.

In FIG. 10, the first K1 taps and last K2 taps form the energy concentration regions and the middle (M−K1−K2) taps form the noise suppression region. Thus, when a DFT is used, K1=L+S and K2=S; and when a DCT is used, K1=2L and K2=0. For other transformations, K1 and K2 may take other values.

It will be noted that the above discussion assumes that the energy concentration region will be at one or both ends of the transform taps and the transform taps in each region will be adjacent to each other. However, it will be appreciated that the energy concentration region for other transformations may include non-adjacent taps.

Therefore, the general weighted channel estimator according to the invention is summarised below.

In particular, the taps in the transform domain are divided into energy concentration taps (that have an effective multiplication coefficient of 1) and noise suppression taps (that are multiplied by the weighting w) according to:

$${q}_{l} = \{ \begin{matrix}w , & for l ∈ A \\ 1 , & for l ∉ A\end{matrix} \qquad ( 20 )$$

and where the weight w is uniform, it is calculated using:

$$w = \frac{{\sum }_{l ∈ A} {\hat{g}}_{LS , l} - length ( A ) \frac{{σ}_{n}^{2}}{{σ}_{s}^{2}}}{{\sum }_{l ∈ A} {\hat{g}}_{LS , l}} \qquad ( 21 )$$

It will be appreciated that the channel estimator 50 according to the invention can be implemented in various types of electronic communication devices, including mobile telephones, PDAs, pagers and communication network base stations.

Therefore, there is provided a channel estimator for a receiver in a communication system that provides a significant performance improvement over a conventional LS channel estimator, without the disadvantages of requiring high complexity and knowledge of the channel characteristics (since they are usually unknown in practice) associated with other designs.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A channel estimator for a receiver in a communication system, the channel estimator comprising:
an input for receiving signals that have been transmitted over a transmission channel;
processing means for:
determining an initial estimate of the channel impulse response of the transmission channel from the received signals, the determined initial estimate comprising a plurality of taps; and
determining a further estimate of the transmission channel from the initial estimate;
wherein the processing means is configured to apply a weighting to a subset of the plurality of taps from the initial estimate in determining the further estimate, the value of the weighting being determined according to a quality of the received signals.

2. A channel estimator as claimed in claim 1, wherein the value of the weighting increases as the quality of the signal increases.

3. A channel estimator as claimed in claim 1 or 2, wherein the value of the weighting is low when the quality of the signal is low and the value of the weighting is high when the quality of the signal is high.

4. A channel estimator as claimed in claim 1, 2 or 3, wherein the value of the weighting tends to 0 as the quality of the signal decreases, and the value of the weighting tends to 1 as the quality of the signal increases.

5. A channel estimator as claimed in any preceding claim, wherein the value of the weighting is uniform across all of the taps in the subset.

6. A channel estimator as claimed in any of claims 1 to 4, wherein the value of the weighting is non-uniform across the taps in the subset.

7. A channel estimator as claimed in any preceding claim, wherein the value of the weighting is determined using a look-up table and the quality of the signal.

8. A channel estimator as claimed in any preceding claim, wherein the plurality of taps comprises M taps, where M is the number of user subcarriers, and wherein the subset of the plurality of taps comprises the (L+S+1)^{th} tap to the (M−S)^{th} tap, where L is the maximum channel delay spread, an estimate of the maximum channel delay spread or the equivalent cyclic prefix length normalised to the user symbol rate and S is a predefined number of taps.

9. A channel estimator as claimed in any preceding claim, wherein the processing means is configured to apply a second weighting to the taps not in the subset of the plurality of taps in determining the further estimate.

10. A channel estimator as claimed in claim 9, wherein the value of the second weighting is 1.

11. A channel estimator as claimed in claim 9, wherein the value of the second weighting is determined according to the quality of the received signals, and wherein the value of the second weighting is equal to or greater than the value of the weighting applied to the subset of taps.

12. A channel estimator as claimed in any preceding claim, wherein the quality of the signal comprises one of a signal to noise ratio, a received signal strength indicator or a channel quality indicator.

13. A channel estimator as claimed in any preceding claim, wherein the initial channel estimate is a least squares channel estimate.

14. A channel estimator as claimed in any preceding claim, wherein the communication system is an orthogonal frequency division multiplexing based communication system, an orthogonal frequency division multiple access with localised subcarrier mapping scheme based communication system, a single-carrier frequency division multiple access based system or a single carrier frequency domain equalisation based communication system.

15. A receiver for use in a communication system, the receiver comprising a channel estimator as claimed in any preceding claim.

16. A method of estimating a channel, the method comprising:
receiving signals that have been transmitted over a transmission channel;
determining an initial estimate of the channel impulse response of the transmission channel from the received signals, the determined initial estimate comprising a plurality of taps; and
determining a further estimate of the transmission channel from the initial estimate by applying a weighting to a subset of the plurality of taps from the initial estimate, wherein the value of the weighting is determined according to a quality of the received signals.

17. A method as claimed in claim 16, wherein the value of the weighting increases as the quality of the signal increases.

18. A method as claimed in claim 16 or 17, wherein the value of the weighting is low when the quality of the signal is low and the value of the weighting is high when the quality of the signal is high.

19. A method as claimed in claim 16, 17 or 18, wherein the value of the weighting tends to 0 as the quality of the signal decreases, and the value of the weighting tends to 1 as the quality of the signal increases.

20. A method as claimed in any of claims 16 to 19, wherein the value of the weighting is uniform across all of the taps in the subset.

21. A method as claimed in any of claims 16 to 19, wherein the value of the weighting is non-uniform across the taps in the subset.

22. A method as claimed in any of claims 16 to 21, wherein the value of the weighting is determined using a look-up table and the quality of the signal.

23. A method as claimed in any of claims 16 to 22, wherein the plurality of taps comprises M taps, where M is the number of user subcarriers, and wherein the subset of the plurality of taps comprises the (L+S+1)^{th} tap to the (M−S)^{th} tap, where L is the maximum channel delay spread, an estimate of the maximum channel delay spread or the equivalent cyclic prefix length normalised to the user symbol rate and S is a predefined number of taps.

24. A method as claimed in any of claims 16 to 23, wherein the step of determining a further estimate further comprises applying a second weighting to the taps not in the subset.

25. A method as claimed in claim 24, wherein the value of the second weighting is 1.

26. A method as claimed in claim 24, wherein the value of the second weighting is determined according to the quality of the received signals, and wherein the value of the second weighting is equal to or greater than the value of the weighting applied to the subset of taps.

27. A method as claimed in any of claims 16 to 26, wherein the quality of the signal comprises one of a signal to noise ratio, a received signal strength indicator or a channel quality indicator.

28. A method as claimed in any of claims 16 to 27, wherein the initial channel estimate is a least squares channel estimate.
